(19) United States
(12) Patent Application Publication
(10) Pub. No.: US 2025/0300204 A1
(43) Pub. Date: Sep. 25, 2025

(54) FUEL CELL SYSTEM

(71) Applicant: TOYOTA JIDOSHA KABUSHIKI KAISHA, Toyota-shi (JP)

(72) Inventors: Takahiro UMEHARA, Susono-shi (JP); Shu MIZUNO, Susono-shi (JP)

(73) Assignee: TOYOTA JIDOSHA KABUSHIKI KAISHA, Toyota-shi (JP)

(21) Appl. No.: 19/002,983

(22) Filed: Dec. 27, 2024

(30) Foreign Application Priority Data
Mar. 21, 2024 (JP) 2024-045293

(51) Int. Cl. H01M 8/04664; H01M 8/04082; H01M 8/04111; H01M 8/0438; H01M 8/04992

(52) U.S. Cl. CPC H01M 8/04686; H01M 8/04111; H01M 8/04201; H01M 8/04388; H01M 8/04992

(57) ABSTRACT

The fuel cell system may include a fuel cell, a hydrogen gas supply path for supplying hydrogen gas to an anode of the fuel cell, a pump for sending off-gas discharged from the anode of the fuel cell to the hydrogen gas supply path, a pressure sensor for measuring a pressure in the hydrogen gas supply path, and a control device. The control device may acquire the amplitude of the frequency component corresponding to the drive frequency of the pump from the time-series data of the measurement value by the pressure sensor, and determine that an abnormality has occurred in the pump when the acquired amplitude is lower than the threshold value.

### CROSS-REFERENCE TO RELATED APPLICATION

This application claims priority to Japanese Patent Application No. 2024-045293 filed on Mar. 21, 2024, incorporated herein by reference in its entirety.

### BACKGROUND

### 1. Technical Field

The technology disclosed by the present specification relates to a fuel cell system that includes a pump.

### 2. Description of Related Art

Japanese Unexamined Patent Application Publication No. 2007-257929 (JP 2007-257929 A) discloses a fuel cell system that includes a pump for circulating hydrogen gas. In the fuel cell system, when the number of revolutions of the pump is less than a predetermined number of times, it is determined that an abnormality has occurred in the hydrogen pump.

### SUMMARY

In the technology of JP 2007-257929 A, a dedicated sensor for measuring the rotational speed of the pump is necessary, in order to determine that an abnormality has occurred in the pump. In the present specification, technology is disclosed that can determine whether or not an abnormality has occurred in the pump, without including a dedicated sensor.

A pulsation of a frequency approximately the same as a drive frequency of the pump can occur in the pressure within the hydrogen gas supply path, by the driving of the pump. On the other hand, if an abnormality occurs in the pump, the pulsation disappears or becomes significantly smaller. Therefore, normality or abnormality of the pump can be determined, by monitoring the pressure in the hydrogen gas supply path and detecting the presence or absence of the pulsation.

Based on the findings, the present specification discloses a fuel cell system.

In one aspect,
a fuel cell system includes
a fuel cell,
a hydrogen gas supply path that supplies hydrogen gas to an anode of the fuel cell,
a pump that delivers an off-gas discharged from the anode of the fuel cell to the hydrogen gas supply path,
a pressure sensor that measures a pressure within the hydrogen gas supply path, and a control device.

The control device is configured to
acquire an amplitude of a frequency component corresponding to a drive frequency of the pump from time-series data of a measurement value by the pressure sensor, and determine that an abnormality has occurred in the pump when the acquired amplitude is less than a threshold.

The configuration enables normality or abnormality of the pump to be determined, by monitoring the pressure within the hydrogen gas supply path and detecting the presence or absence of a pulsation. Here, in the fuel cell system that includes a pump, a pressure sensor is usually provided in order to monitor and adjust a flow rate of hydrogen gas supplied to the fuel cell. In the configuration, normality or abnormality of the pump can be determined, by using the pressure sensor. In this way, it is not necessary to provide a new sensor, such as a sensor that measures the number of revolutions of the pump, for example, in order to determine normality or abnormality of the pump.

In a second aspect, in the first aspect,
the pump may be a positive displacement pump.

In a positive displacement pump, since compression and release of hydrogen gas is repeated at a predetermined frequency (namely, a drive frequency), a pulsation caused by the compression and release easily appears in the pressure within the hydrogen gas supply path. Therefore, if the pump is a positive displacement pump, normality or abnormality of the pump can be more accurately determined.

In a third aspect, in the second aspect,
the pump may be a diaphragm pump.

In a diaphragm pump, a pulsation caused by the reciprocation of the diaphragm easily appears in the pressure within the hydrogen gas supply path. Therefore, if the pump is a diaphragm pump, normality or abnormality of the pump can be more accurately determined.

In a fourth aspect, in any one of the first to third aspects, the control device may execute a frequency analysis with respect to the time-series data of the measurement value by the pressure sensor to obtain the amplitude of the frequency component corresponding to the drive frequency of the pump.

In this case, while not particularly limited, a frequency analysis of the time-series data may be performed, by executing a Fourier transform with respect to the time-series data of the measurement value.

In a fifth aspect, in any one of the above first to fourth aspects, the control device may be configured to be able to change the threshold.

As described, a pulsation occurs in the pressure within the hydrogen gas supply path, by the driving of the pump. However, the magnitude of the pulsation varies in accordance with a specific configuration of the fuel cell system, such as the hydrogen gas supply path and the specifications of the pump. Therefore, a threshold used by the control device may be able to be changed, for example, in accordance with the specific configuration of the fuel cell system. Note that, while an example, a threshold used by the control device can be determined in accordance with a minimum value of the pulsation that is assumed when the pump is operating normally.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of a fuel cell system; and

FIG. 2 is a flowchart of processing executed by the control device.

### DETAILED DESCRIPTION OF EMBODIMENTS

A fuel cell system 10 according to an embodiment will be described with reference to the drawings. The fuel cell system 10 according to the present embodiment is mounted on a fuel cell electric vehicle, various moving bodies other than vehicles (for example, a train, a ship, or the like), a stationary fuel cell device, or the like. Hereinafter, a fuel cell is referred to as an abbreviation for FC (FuelCell).

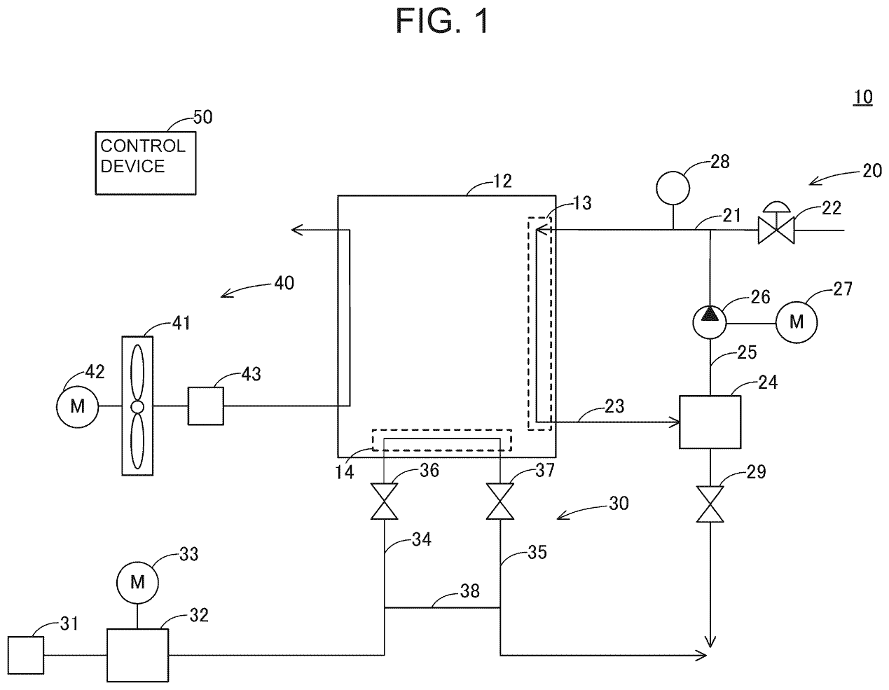

As shown in FIG. 1, the fuel cell system 10 includes a FC stack 12, a hydrogen gas supply unit 20, an air supply unit 30, a cooling unit 40, and a control device 50. FC stack 12 is provided with an anode 13 and a cathode 14. The hydrogen gas supply unit 20 supplies hydrogen gas containing hydrogen to the anode 13 of FC stack 12. The air supply unit 30 supplies oxygen-containing air to the cathode 14 of FC stack 12. In FC stack 12, hydrogen contained in the hydrogen gas supplied from the hydrogen gas supply unit 20 and oxygen contained in the air supplied from the air supply unit 30 chemically react with each other to generate electric power. FC stacks 12 generate heat when generating electricity. A cooling unit 40 is provided for cooling FC stacks 12. The control device 50 controls the respective devices (for example, the injector 22, the pump 26, and the like) of the respective units 20, 30, and 40.

The hydrogen gas supply unit 20 includes a hydrogen gas supply path 21, an injector 22, an exhaust drain path 23, a gas-liquid separator 24, a circulation path 25, a pump 26, a motor 27, a pressure sensor 28, and an exhaust drain valve 29. Hydrogen gas supplied from a hydrogen tank (not shown) is supplied to the anode 13 of FC stack 12 via a hydrogen gas supply path 21. The injector 22 is provided on the hydrogen gas supply path 21, and controls the supply of the hydrogen gas supplied from the hydrogen tank to FC stack 12. The off-gas discharged from the anode 13 and the water generated by the chemical reaction in FC stack 12 are supplied to the gas-liquid separator 24 via the exhaust drain path 23. In the gas-liquid separator 24, a part of the above-described off-gas and water are removed. An exhaust drain valve 29 is provided in the exhaust drain path 23, and a part of the above-described off-gas and water are discharged to the outside by opening the exhaust drain valve 29.

In the circulation path 25, a pump 26 is provided in the circulation path 25 extending from the exhaust drain path 23 to the hydrogen gas supply path 21 via the gas-liquid separator 24. The pump 26 is operated by electric power supplied by the motor 27. The remaining off-gas that has not been removed by the gas-liquid separator 24 is sent to the hydrogen gas supply path 21 by the driving of the pump 26. The pump 26 of the present embodiment is a diaphragm pump. A diaphragm pump is a type of positive displacement pump. However, the type of pump 26 is not limited to a diaphragm pump. The type of pump 26 may be, for example, other positive displacement pumps (e.g., piston pumps, plunger pumps, gear pumps, etc.). The type of pump 26 may be a non-positive displacement pump (e.g., a spiral pump, a turbine pump, an axial flow pump, etc.).

The pressure sensor 28 measures the pressure in the hydrogen gas supply path 21. The pressure in the hydrogen gas supply path 21 is provided to monitor and regulate the flow rate of the hydrogen gas to be supplied to FC stack 12. In particular, since the pump 26 of the present embodiment is a diaphragm pump, when the pump 26 is driven, the off-gas is periodically supplied to the hydrogen gas supply path 21 due to the driving cycle of the pump 26. As a result, the pressure in the hydrogen gas supply path 21 varies periodically (i.e., pulsation occurs). That is, in such a situation, the measurement value of the pressure sensor 28 fluctuates periodically. Here, the driving cycle of the pump 26, which is a diaphragm pump, means a time period during which the diaphragm reciprocates.

The air supply unit 30 includes an air filter 31, an air blower 32, a motor 33, an air supply path 34, an air discharge path 35, a pressure regulating valve 36, a back pressure valve 37, and a flow dividing path 38. The air blower 32 is connected to the cathode 14 of FC stacking 12 via the air supply path 34. Therefore, the air supplied from the outside through the air filter 31 is compressed by the air blower 32, and at least a part of the air is supplied to FC stacking 12 through the air supply path 34. The air supplied to FC stacking unit 12 is discharged to the outside through the air discharge path 35. Further, when the flow dividing valve (not shown) provided in the flow dividing path 38 is open, the remainder of the air compressed by the air blower 32 is discharged to the outside from the air discharge path 35 via the flow dividing path 38. The air blower 32 is operated by electric power supplied from the motor 33. The pressure regulating valve 36 regulates the pressure of the air supplied to FC stacking 12. The back pressure valve 37 regulates the pressure of the air discharged from FC stacking 12.

The cooling unit 40 includes a cooling fan 41, a motor 42, and an air filter 43. That is, the cooling unit 40 of the present embodiment is an air-cooled cooling unit. In a modification, the cooling unit 40 may be a water-cooled cooling unit using a liquid refrigerant. The cooling fan 41 is operated by electric power supplied from the motor 42. The air compressed by the cooling fans 41 is supplied to FC stack 12 through the air filters 43 to cool FC stack 12. The air cooled by FC stack 12 is discharged to the outside of FC stack 12.

In the above-described configuration, when an abnormality occurs in the pump 26, the off-gas cannot be supplied to the hydrogen gas supply path 21, or the supply amount of the off-gas to the hydrogen gas supply path 21 is significantly reduced. As a result, the quantity of hydrogen gas supplied to FC stacks 12 may be insufficient. If power generation is continuously performed in FC stack 12 in such a condition, the power generation of FC stack 12 may be reduced or FC stack 12 may be an abnormality. Therefore, the control device 50 of the present embodiment executes a process of determining whether or not an abnormality has occurred in the pump 26.

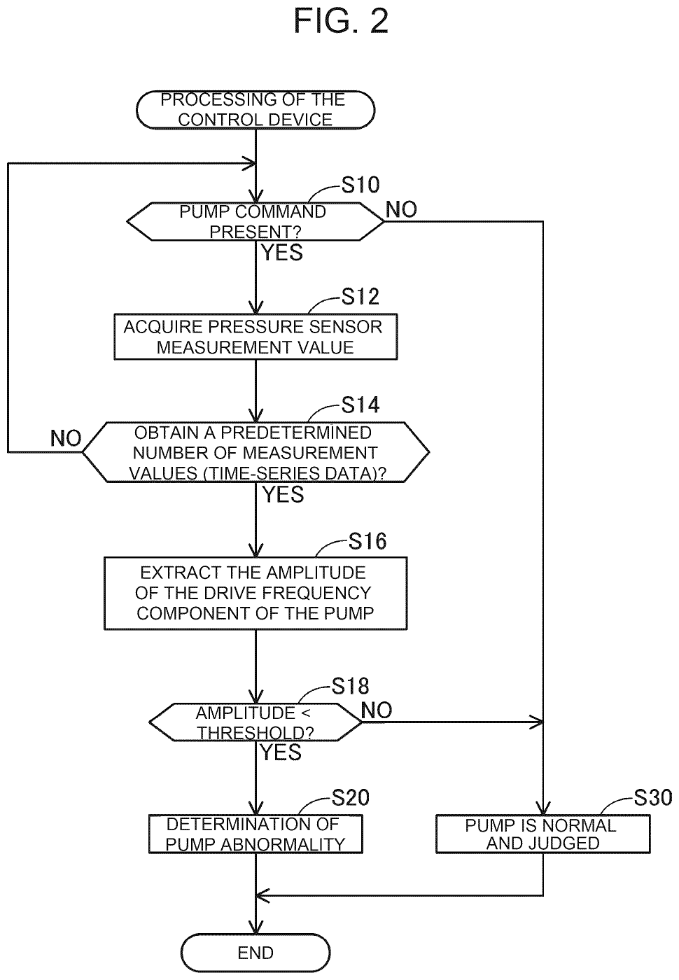

Next, with reference to FIG. 2, a process of determining whether or not an abnormality has occurred in the pump 26, which is executed by the control device 50, will be described. The process of FIG. 2 is repeatedly executed when FC device 10 is in operation. For example, the process of FIG. 2 may be repeatedly executed at a certain cycle when FC device 10 is in operation.

In S10, the control device 50 determines whether or not a command value to the pump 26 (more specifically, a command value to the motor 27 that supplies electric power for driving the pump 26) is being outputted. When the command value to the pump 26 is output (YES in S10), the control device 50 proceeds to S12, and when the command value to the pump 26 is not output (NO in S10), the control device proceeds to S30.

When the command value to the pump 26 is output, the control device 50 executes a process of acquiring a predetermined number of measurement values of the pressure sensor 28 at a predetermined cycle (sample cycle). Specifically, the control device 50 first acquires the measurement value of the pressure sensor 28 in S12 when it is determined as YES in S10. Thereafter, the control device 50 determines whether a predetermined number of measurement values of the pressure sensor 28 have been acquired in S14. When it is determined that a predetermined number of measurement values of the pressure sensor 28 have been acquired (YES in S14), the control device 50 proceeds to S16, and when it is determined that a predetermined number of measurement values of the pressure sensor 28 have not been acquired (NO in S14), the control device repeatedly executes the processes of S10 and S12. That is, the control device 50 repeats the process of S10 to S14 until time-series data including a predetermined number of measurement values is acquired. The process of S12 after NO in S14 is executed at a timing at which the sampling period has elapsed since the previous S12 process was executed. In this way, at the stage where S14 is determined to be YES, the control device 50 stores the time-series data of the measurement values of the predetermined number of pressure sensors 28 acquired each time the sampling period arrives.

In the present embodiment, the sample period is set to half the time of the drive period of the pump 26. The reason for this is to make it possible to reproduce the pressure fluctuations (i.e., continuous changes) due to the actual operation of the pump 26 by the time-series data of the measurement values of the pressure sensor 28 (sampling theorem). Further, in the present embodiment, the predetermined number is set to a number that can be acquired in 10 cycles of the drive cycle of the pump 26. For example, when the driving period 20 ms of the pump 26 is satisfied, the sample period is 10 ms, and the predetermined number is 20 ((length 200 ms of 10 periods)/(sample period 10 ms)). Note that the sample period and the predetermined number are examples, and other numerical values may be adopted. In particular, the higher the predetermined number, the higher the accuracy of the determination of normality or abnormality of the pump 26, but it takes a long time to perform the determination.

In S16, the control device 50 extracts the amplitude of the drive frequency component of the pump 26 based on the stored time-series data. Specifically, the control device 50 performs frequency analysis (for example, Fourier transform) on the stored time-series data, and acquires the amplitude of the frequency component corresponding to the drive frequency of the pump 26. In the modified example, the control device 50 may include hardware for extracting an amplitude of a frequency component such as a lock-in amplifier. Then, the amplitude of the drive frequency component of the pump 26 may be extracted by using the lock-in amplifier.

In S18, the control device 50 determines whether or not the amplitude extracted by S16 is lower than the threshold. Here, the threshold value is configured to be changeable. For example, the threshold value may be a value determined from the minimum value of the pressure fluctuation amount in the hydrogen gas supply path 21 that is assumed when the pump 26 is normal. The threshold value may be a value determined based on an index representing a characteristic of the other pump 26, the hydrogen gas supply path 21, or the like. In the modified example, the threshold value may be a fixed value set for the pump 26. The control device 50 proceeds to S20 (YES in S18) if the amplitude is below the threshold value and proceeds to S30 (NO in S18) if the amplitude is greater than or equal to the threshold value.

In S20, the control device 50 determines that an abnormality has occurred in the pump 26. In this case, although not illustrated, the control device 50 may execute a process for notifying the user that an abnormality has occurred in the pump 26. When the process of S20 ends, the process of FIG. 2 ends.

In S30, the control device 50 determines that no abnormality has occurred in the pump 26. When the process of S30 ends, the process of FIG. 2 ends.

According to the above configuration, the control device 50 monitors the pressure in the hydrogen gas supply path 21 by the pressure sensor 28. Then, the control device 50 analyzes the time-series data of the pressure and detects the presence or absence of pulsation corresponding to the drive frequency of the pump 26. Thus, the control device 50 can determine whether the pump 26 is normality or abnormality. Here, in FC device 10 including the pump 26, a pressure sensor 28 is conventionally provided to monitor and regulate the flow rate of the hydrogen gas supplied to FC stack 12. In the above configuration, by using the pressure sensor 28, it is not necessary to provide a new sensor for determining normality or abnormality of the pump (for example, a sensor for measuring the rotational speed of the pump 26).

In particular, as described above, in the technique of the present embodiment, normality or abnormality of the pump 26 is determined based on the pressure fluctuation (i.e., pulsation) in the hydrogen gas supply path 21. For this reason, the technique of the present embodiment is particularly useful for FC system 10 in which a type of pump in which pressure variation in the hydrogen gas supply path 21 is remarkably caused by the operation of the pump 26 is adopted, such as the diaphragm pump of the embodiment. For example, the present disclosure is not limited to a diaphragm pump, and when a positive displacement pump is employed, such pressure fluctuation is likely to occur. Alternatively, even when a non-positive displacement pump is employed, pressure fluctuations depending on the drive frequency can be observed when the drive frequency (i.e., the rotational speed of the impeller) is relatively small.

FC stacking 12 is an exemplary “fuel cell” of the present technique.

While specific examples of the technology disclosed in the present specification have been described in detail above, these examples are merely illustrative and do not limit the scope of the claims. The technique described in the claims includes various modifications and variations of the specific examples exemplified above. The technical elements described in this specification or in the drawings may be used alone or in various combinations, and are not limited to the combinations described in the claims at the time of filing. In addition, the technique exemplified in the present specification or drawings can achieve a plurality of purposes at the same time, and achieving one of the purposes itself has technical usefulness.

What is claimed is:

1. A fuel cell system comprising:
a fuel cell;
a hydrogen gas supply path that supplies hydrogen gas to an anode of the fuel cell;
a pump that delivers an off-gas discharged from the anode of the fuel cell to the hydrogen gas supply path;
a pressure sensor that measures a pressure within the hydrogen gas supply path; and
a control device, wherein the control device is configured to
acquire an amplitude of a frequency component corresponding to a drive frequency of the pump from time-series data of a measurement value by the pressure sensor, and
determine that an abnormality has occurred in the pump when the acquired amplitude is less than a threshold.

2. The fuel cell system according to claim 1, wherein the pump is a positive displacement pump.

3. The fuel cell system according to claim 2, wherein the pump is a diaphragm pump.

4. The fuel cell system according to claim 1, wherein the control device executes a frequency analysis with respect to the time-series data of the measurement value by the pressure sensor to obtain the amplitude of the frequency component corresponding to the drive frequency of the pump.

5. The fuel cell system according to claim 1, wherein the control device is configured to be able to change the threshold.
